(19) United States
(12) Patent Application Publication
(10) Pub. No.: US 2025/0259086 A1
(43) Pub. Date: Aug. 14, 2025

(54) AUTOMATED AGENT CHAIN-OF-THOUGHT RESPONSE GENERATION USING STRUCTURE-BASED CONSTRAINTS

(71) Applicant: Scaled Cognition, Inc., Amesbury, MA (US)

(72) Inventors: Arya McCarthy, Baltimore, MD (US); Adam Pauls, Berkeley, CA (US); Emmanouil Antonios Platanios, Fremont, CA (US); Mitchell Stern, Berkeley, CA (US); Matthew Gardner, Irvine, CA (US)

(73) Assignee: Scaled Cognition, Inc., Amesbury, MA (US)

(21) Appl. No.: 18/606,237

(22) Filed: Mar. 15, 2024

Related U.S. Application Data
(60) Provisional application No. 63/551,536, filed on Feb. 9, 2024.

(51) Int. Cl. G06N 5/046

(52) U.S. Cl. CPC G06N 5/046

(57) ABSTRACT

A system generates a response to a change of state by an automated agent using structure-based constraints. The system receives input regarding an interaction with a client, external data, and current operations data. The received input is used to generate a content sketch. The content sketch can include a plan for how to generate the response. The program language can be constrained to a set of known atoms, such as for example particular specified function, values, and flow control. Relevant instructions for generating a response are generated from the content sketch and an instruction bank. The relevant instructions are then used to generate a response. The generated response may then be executed by the automated agent system.

### REFERENCE TO RELATED APPLICATIONS

The present application claims the priority benefit of U.S. provisional patent application 63/551,536, filed on Feb. 9, 2024, titled “Automated Agent Chain-of-Thought Response Generation Using Structure-Based Constraint,” the disclosure of which is incorporated herein by reference.

### BACKGROUND OF THE INVENTION

Computer systems that reason, plan, and communicate with machine learning models often rely on multi-step generation to determine an appropriate action or response. In some cases, a computer system produces a natural language response in response to a customer query. Previous systems utilize pre-planned messages which are provided to a customer based on the customer query. These pre-planned messages limit the scope of a response allowed for the computer system, and often times are not correct. What is needed is an improved system for interacting with a customer.

### SUMMARY OF THE INVENTION

The present technology, roughly described, generates a response to a change of state by an automated agent using structure-based constraints. The system receives input regarding an interaction with a client, external data, and current operations data. The received input is used to generate a content sketch. In some instances, a response planning model receives the input and generates the content sketch. The content sketch can include a plan for how to generate the response. The content sketch can be constrained, unconstrained, or include both constrained and unconstrained components.

In some instances, the content sketch may be expressed as or include a program or some other schematized abstract meaning representation. The program language can be constrained to a set of known atoms, such as for example particular specified function, values, and flow control. In some instances, the content sketch can be represented in an unconstrained form such as arbitrary text or a vectorial representation.

Relevant instructions for generating a response are generated from the content sketch and an instruction bank. The relevant instructions are then used to generate a response. In some instances, an instruction selection model is used to generate the relevant instructions, and a response generation model is used to generate the response. The generated response may then be executed by the automated agent system.

In some instances, the present technology performs a method for generating a response to a change of state using structure-based constraints. The method begins with detecting a change of state by an automated agent during a conversation. Conversational context, external world state representation, and current agent operations data associated with the conversation are accessed. A content sketch is generated based on the accessed conversational context, external world state representation, and current agent operations data. The content sketch is generated using a first machine learning model, wherein the content sketch includes a set of one or more programs. A response is prepared based at least in part on the content sketch and a first set of instructions, the first set of instructions identified based on the content sketch and the change of state.

In some instances, the present technology includes a non-transitory computer readable storage medium having embodied thereon a program, the program being executable by a processor to generate a response to a change of state using structured based constraints. The process begins with detecting a change of state by an automated agent during a conversation. Conversational context, external world state representation, and current agent operations data associated with the conversation are accessed. A content sketch is generated based on the accessed conversational context, external world state representation, and current agent operations data. The content sketch is generated using a first machine learning model, wherein the content sketch includes a set of one or more programs. A response is prepared based at least in part on the content sketch and a first set of instructions, the first set of instructions identified based on the content sketch and the change of state.

In some instances, the present technology includes a system having one or more servers, each including memory and a processor. One or more modules are stored in the memory and executed by one or more of the processors to detect a change of state by an automated agent during a conversation, access conversational context, external world state representation, and current agent operations data associated with the conversation, generate a content sketch based on the accessed conversational context, external world state representation, and current agent operations data, the content sketch generated using a first machine learning model, the content sketch including a set of one or more programs, and prepare a response based at least in part on the content sketch and a first set of instructions, the first set of instructions identified based on the content sketch and the change of state.

### BRIEF DESCRIPTION OF FIGURES

FIG. 1 illustrates a flow chart for generating a response to a change of state by an automated agent using structured based constraints.

FIG. 2 illustrates more detail for the flow chart of FIG. 1.

FIG. 3 illustrates a block diagram of input received for a response planning model.

FIG. 4 illustrates a block diagram of a system for generating a response to a change of state by an automated agent using structured based constraints.

FIG. 5 illustrates a block diagram of an automated agent application.

FIG. 6 illustrates a block diagram of dataflow for a machine learning model.

FIG. 7 illustrates a method for implementing a structured chain of thought.

FIG. 8 illustrates a method for generating a content sketch.

FIG. 9 illustrates a method for modifying a content sketch based on program constraints.

FIG. 10 illustrates a method for generating relevant instructions by a machine learning model.

FIG. 11 illustrates a method of generating a response by a machine learning model.

FIG. 12 is a block diagram of a computing environment.

### DETAILED DESCRIPTION

The present technology, roughly described, generates a response to a change of state by an automated agent using structure-based constraints. The system receives input regarding an interaction with a client, external data, and current operations data. The received input is used to generate a content sketch. In some instances, a response planning model receives the input and generates the content sketch. The content sketch can include a plan for how to generate the response. The content sketch can be constrained, unconstrained, or include both constrained and unconstrained components.

In some instances, the content sketch may be expressed as or include a program or some other schematized abstract meaning representation. The program language can be constrained to a set of known atoms, such as for example particular specified function, values, and flow control. In some instances, the content sketch can be represented in an unconstrained form such as arbitrary text or a vectorial representation.

Relevant instructions for generating a response are generated from the content sketch and an instruction bank. The relevant instructions are then used to generate a response. In some instances, an instruction selection model selects the relevant instructions from the instruction bank based on the content sketch and the received input, and a response generation model is used to generate the response. The generated response may then be executed by the automated agent system.

The present application is advantageous over prior systems for several reasons. Previous systems have attempted to generate a response based on conversation data alone. The current system generates a response based on multiple inputs including conversational data, external world state representation, and current operations and results. Further, the present system generates a content sketch based on these multiple inputs. The content sketch is generated as a plan for generating a response, based on the multiple inputs. Additionally, the content sketch is constrained to a set of known functions and values. Hence, the content sketch may include one or more programs, and the constraint applied to the content sketch may further limit, modify, or “constrain” one or more programs in the content sketch in some way.

In some instances, the advantage of the present technology is that the generated response is more likely to be correct and useful because the content sketch serves as a planning step. The presence of an explicit plan shifts the system from short-horizon decision making to long-horizon decision making.

The present system is not forced to choose between a set of known responses. Rather, the present system is constrained, through a content sketch, to using a set number of programs, but allows the present system to freely generate a response, conditioned on the constrained choice. In some instances, there may be no limit to the number of programs. While previous systems have attempted use of LLMs to generate totally unconstrained responses, the present technology uses, in some instances, a mixed approach of some constrained pre-planning but still unconstrained responses.

Some examples of a change of state include, but are not limited to, a message from the user, a response received from a remote procedure call (e.g. whether a reservation attempt succeeded and what the confirmation number is), an overlong delay since the last message received from the user, and, in a robotics context, some sensory input received.

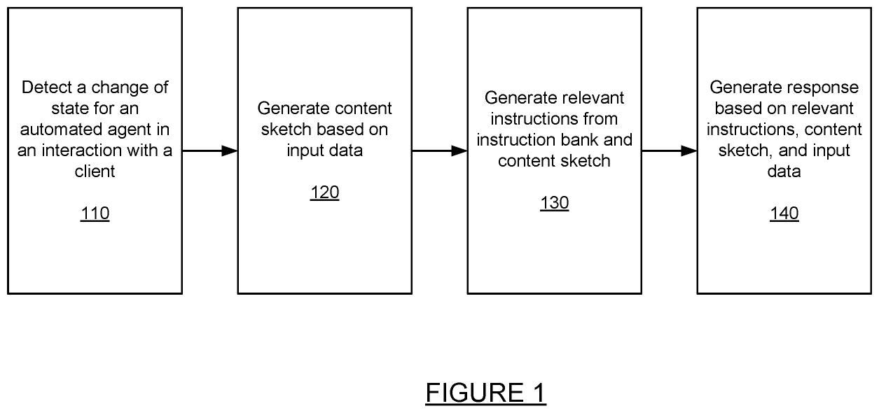

FIG. 1 illustrates a flow chart for generating a response to a change of state by an automated agent using structure-based constraints. The flowchart of FIG. 1 begins with detecting a change of state for an automated agent at step 110. The automated agent may be involved with an interaction with a client. The interaction can include a conversation, a navigation of an environment, or other interaction. The change of state may be detected in response to receiving a communication from a client, such as for example through a conversational application between a client and the automated agent. The change of state may also be an operation performed by an automated agent, such as for example determining a location of a destination, a result obtained by an automated agent in response to a client query, or a program executed by the automated agent.

Once a change state is detected, a content sketch may be generated at step 120. The content sketch is based on input data received by the present system from a remote source or a local source. The content sketch can include a plan for how to generate a response and be expressed as a program or other schema tied to an abstract meaning representation.

Relevant instructions may be generated at step 130. The relevant instructions can be generated from an instruction bank and the content sketch generated at step 120. The relevant instructions are used to generate a response.

A response can be generated at step 140. The response is generated based on one or more of the relevant instructions, the content sketch, and the input data. The input data may include the data used to generate the content sketch at step 120. The response may be generated by a machine learning model, such as for example a large language model, and may be executed or performed by the automated agent. For example, the response can be a message to the client regarding a flight that was booked in response to a client query, a confirmation number for a car rental, instructions for moving forward in a navigational application, or some other action.

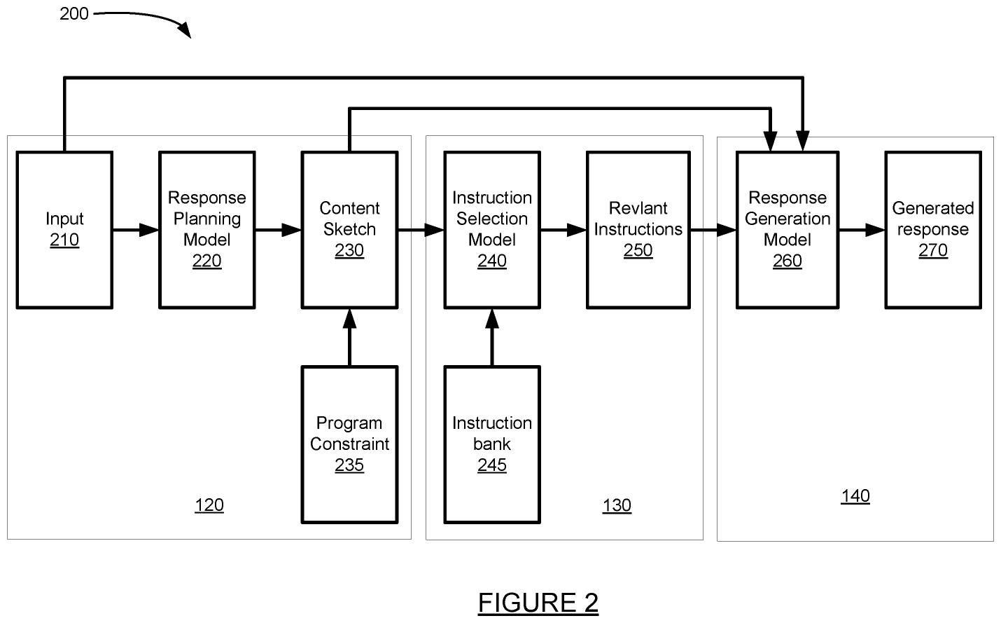

FIG. 2 illustrates more detail for the flow chart of FIG. 1. In particular, the flow cart of FIG. 2 provides more detail for steps 120, 130 and 140 of FIG. 1.

Step 120 involves input data 210, response planning model 220, content sketch 230, and program constraint 235. After detecting a state, response planning model 220 receives input data 210. The input data can include conversation data, external world state representation data, and operation and results data. Conversation data may include a record of previous turns of an interaction between an automated agent and the client, the world, or some other entity. Conversation data may include the messages exchanged as well as actions taken by the present system in response to the client messages, queries, or other interactions. The external world state representation can include a representation of the state of systems which the automated agent interacts with. Examples of these systems may include sensor inputs, input devices, microphones, and other devices. The operations data may include programs, procedures, and partial reasoning traces generated during the present turn of the interaction between the automated agent application communicating with a client. The operations data generated in the present turn can be generated to effectuate a goal, for example a program to book a client's flight and the resulting confirmation number. Another example of operation data includes a command to move forward in an environment in the resulting uploaded coordinates from a world model. In some instances, where no operations are performed in the present turn within the interaction, the operations data may include a null.

The input is received by response planning module 220. The response planning model can be a machine learning model, content generation logic, or some other tool that can generate a content sketch. In some instances, the input is provided to response planning model 220 in the form of a prompt.

Model 220 receives the input, processes the input, and generates a content sketch 230. The content sketch can be expressed as a program or some other schema tied to an abstract meaning representation. In this instance, the program language can be constrained to a set of known atoms, such as particular specified functions, values, and flow control. In some instances, the content sketch may be represented in an unconstrained form such as arbitrary text or vectorial representation. In some instances, the content sketch may include both constrained and unconstrained components.

A program constraint 235 may be applied to content sketch 232. The program constraint can constrain a program within the content sketch. The constraint can limit the values of a value, a variable, a particular program to access or execute, or provide some other constraint. For example, a program constraint generated by response planning model 220 may be a program to provide a client with a refund. The program constraint, in this example, may provide that the refund is limited to no more than $100.00. By applying the constraint, the present system can select instructions and/or generate a response more efficiently.

Within step 130, content sketch 230 provided to instruction selection model 240 along with a set of instructions from instruction bank 245. The instruction bank may include a collection of instructions expressed in natural language or formal rules. The collection of instructions may validate the content sketch and optionally provide additional information for how to generate a response. There may be general instructions pertaining to the agent in all scenarios, as well as specific instructions for specific scenarios. In some instances, for example as an optimization, when a parser or recognizer is used to validate a constrained content sketch, a validation can occur in-line rather than post hoc by, for example, constrained decoding.

The instruction selection model selects a relevant subset of the set of instructions from instruction bank 245 based on the content sketch 230. The relevant instructions can be generated by a machine learning model, such as a large language model, which receives the content sketch and a set of instructions from the instruction bank as input. The machine learning model processes the input and then outputs the instructions.

In step 140, a response generation model generates a response to the detected change of state. Response generation model 260 receives the relevant instructions, content sketch 230, and input 210. In some instances, these inputs may be received in the form of a prompt for a large language model that implements response generation module 260. The response generation model receives the inputs, processes the inputs to generate a response, and outputs a generated response 270 at step 140.

The generated response 270 may be generated by a machine learning model, such as for example a large language model. For example, the response can be a message to the client regarding a flight that was booked in response to a client query, a confirmation number for a car rental, instructions for moving forward in a navigational application, or some other action.

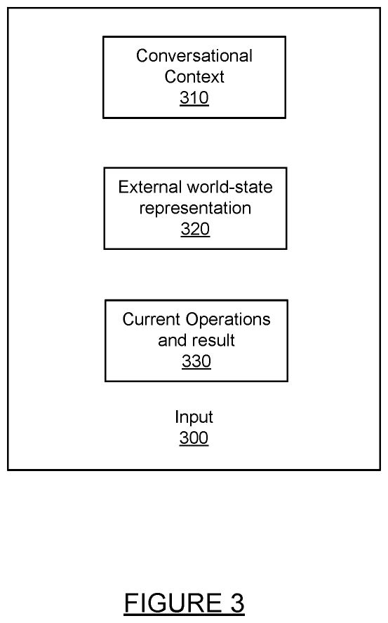

FIG. 3 illustrates a block diagram of input received by a response planning model. Input 300 of FIG. 3 provides more detail for input 210 of FIG. 2. Input 300 includes conversational context, external world state representations, and current operations and results. Conversational context can include a record of previous turns of interactions between an automated agent and a client. For example, when the automated agent provides a customer service system. In some instances, the interaction may be between the automated agent and the world, for example in the case of a navigation system. The conversation context may include data exchange between the two entities during the interaction. For example, for a customer service system, the conversational context may include text messages provided by each of the automated agent and the client to each other during the interaction. The conversational context may also include actions performed by the automated agent in response to client messages or other events. In the case of a navigation system, the conversational context may include or search terms for a destination, and directions provided. The conversational context may also provide speed information and other data for a navigation system.

The external world state presentation may include a representation of the state of systems with which the automated agent interacts. The agent may interact with sensor inputs, global positioning system inputs, computing device inputs, and other inputs that provide data or information to an automated agent during an interaction with a client.

Current operations and results include programs, procedures, and partial reasoning traces generated during the present interaction by the present system in order to effectuate a goal. For example, the current operations and result may include a program to book a client's flight and the resulting confirmation number, a car rental and a confirmation number, or a command to move forward in the environment and the resulting updated coordinates from the world model. In some instances, the current operations and result may include a null value if no operation is performed.

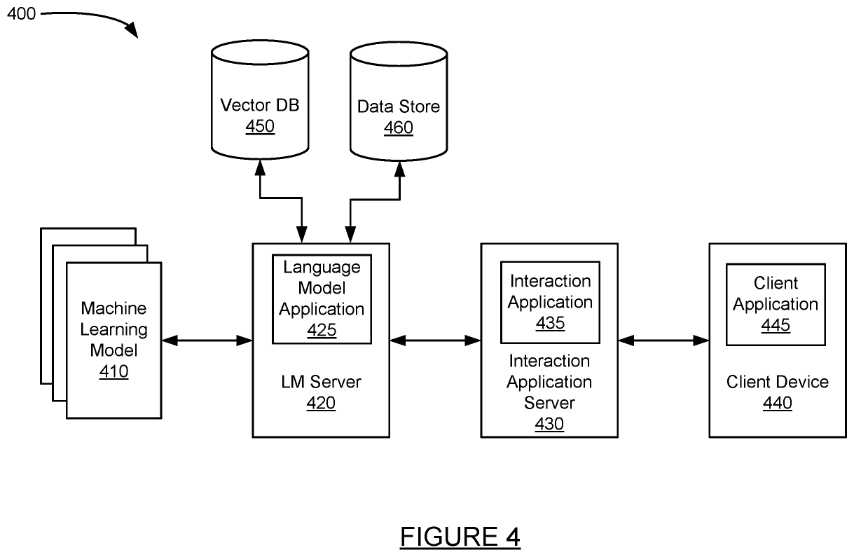

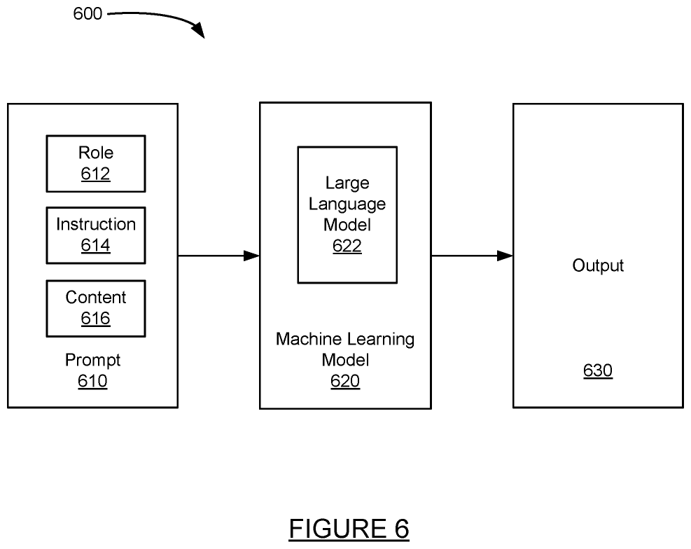

FIG. 4 illustrates a block diagram of a system for generating a response to a change of state by an automated agent using structured based constraints. Machine learning model 410 may include one or more models or prediction engines that may receive an input, process the input, and provide an output based on the processing of the input. In some instances, machine learning model 410 may be implemented on LM server 420, on the same physical or logical machine as language model application 425. In some instances, machine learning model 410 may be implemented by a large language model, on one or more servers external to LM server 420. Implementing the machine learning model 410 as one or more large language models is discussed in more detail with respect to FIG. 6.

LM server 420 may include an LM application 425, and may communicate with machine learning model 410, chat application server 430, and vector database 450. LM application 425 may be implemented on one or more servers 420, may be distributed over multiple servers and platforms, and may be implemented as one or more physical or logical servers.

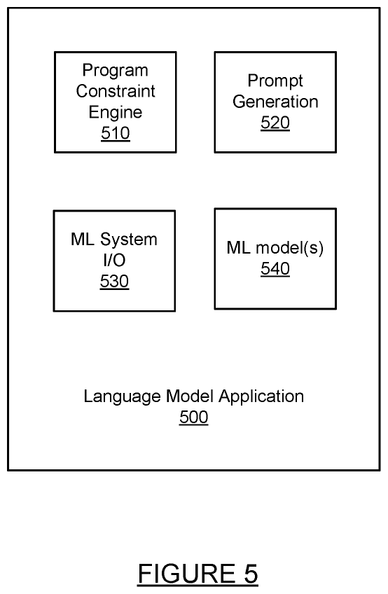

LM application 425 may include several modules that implement the functionality described herein. For example, language model application 425 can generate a content sketch, generate relevant instructions, and generate a response using one or more machine learning models 410. More details for language model application 425 are discussed with respect to FIG. 5.

Interaction application server 430 may communicate with LM server 420, client device 440, and may implement an interaction over a network, such as for example a “chat,” between an automated agent application provided by LM server 420 and client device 440 associated with a client. The interaction may be a chat, text conversation between an automated agent and a client, interaction between a client and a navigation system, or some other interaction.

Vector database 450 may be implemented as a data store that stores vector data. In some instances, vector database 450 may be implemented as more than one data store, internal to the automated agent system provided by LM server 420 and exterior to system 420. In some instances, a vector database can serve as an LLMs' long-term memory and expand an LLMs' knowledge base. Vector database 450 can store private and/or confidential data or domain-specific information outside the LLM as embeddings. In some instances, vector database provides an instruction bank to LM application 425. When a client asks a question to the automated agent system, the system can have the vector database search for the top results, such as for example instructions, most relevant to the received question. Vector database 450 may include data such as prompt templates, instructions, training data, and other data used by LM application 425 and machine learning model 410.

In some instances, the present system may include one or more additional data stores, such as data store 460, in place of or in addition to vector database 450, at which the system stores searchable data such as instructions, private data, domain-specific data, and other data.

Each of model 410, servers 420-440, vector database 450, and data store 460 may communicate over one or more networks. The networks may include one or more the Internet, an intranet, a local area network, a wide area network, a wireless network, Wi-Fi network, cellular network, or any other network over which data may be communicated.

In some instances, one or more of machines associated with 410, 420, 430, 440, 450 and 460 may be implemented in one or more cloud-based service providers, such as for example AWS by Amazon Inc, AZURE by Microsoft, GCP by Google, Inc., Kubernetes, or some other cloud based service provider.

The system of FIG. 4 illustrates a language model application within a chat system formed with ML model 410, LM server 420, interaction application server 430, and client device 440. Illustration of the language model in a chat or automated agent system is for purposes of discussion only, and the language model of the present technology is not intended to be limited to chat systems alone.

FIG. 5 illustrates a block diagram of a language model application. Language model application 500 of FIG. 5 provides more detail for application 425 of the system of FIG. 4. Language model application 500 includes program constraint engine 510, prompt generation 520, machine learning system input-output 530, and machine learning models 540.

Program constraint engine 510 may apply a program constraint to a content sketch. The program constraint may apply a constraint on the programs contained in content sketch 230. The constraint can limit a program value, variable, a particular program to access or execute, or provide some other constraint. For example, a content sketch generated by response planning model 220 may be a program to provide a client with a refund. The program constraint on the program sketch, in this example, may provide that the refund is limited to no more than $100.00, or that an approval by a manager role is required before a refund is provided that is greater than $100.00. By applying the constraint, the present system can select instructions and/or generate a response more efficiently. Additionally, the system will be more likely to follow its instructions if it can select the instructions accurately.

Prompt Generation 520 may generate a prompt to be received by measuring learning model, including but not limited to a large language model. Prompt generation 520 may prepare elements of a prompt such as a role, instructions, content, and other data or information within a prompt. A generated prompt may include a request to generate a content sketch, select relevant instructions, or generate a response based on a changed state.

Machine learning system I/O 530 may provide a prompt as input to a machine learning model and receive an output from the machine learning model. In some instances, machine learning system input/output 530 may provide inputs to and retrieve outputs from response planning module 220, instruction selection model 240, in response generation model 260 of the system of FIG. 2.

Machine learning models 540 may include one or more models that can receive input and provide an output. The machine learning models may include one or more machine learning models that generate a content sketch, select relevant instructions, prepare a response, prepare a prediction, as well as perform other tasks. The machine learning models 240 can include one or more LLMs, as well as a combination of LLMs and ML models.

Modules illustrated in language model application 200 are exemplary, and could be implemented in additional or fewer modules. Language model application 200 is intended to at least implement functionality described herein. The design of specific modules, objects, programs, and platforms to implement the functionality is not specific and limited by the modules illustrated in FIG. 2.

FIG. 6 is a block diagram of data flow for a machine learning model. The block diagram of FIG. 6 includes prompt 610, machine learning model 620, and output 630.

Prompt 610 of FIG. 6 can be provided as input to a machine learning model 620. A prompt can include information or data such as a role 612, instructions 614, and content 616. The role indicates the authority level at which the automated agent is to assume while working to assist a user. For example, a role can include an entry-level customer service representative, a manager, a director, or some other customer service job with a particular level of permissions and rules that apply to what they can do and cannot do when assisting a customer.

Instructions 614 can indicate what the machine learning model (e.g., a large language model) is supposed to do with the other content provided in the prompt. For example, the machine learning model instructions may request, via instructions 614, an LLM to select the most relevant instructions from content 616 to train or guide a customer service representative having a specified role 612, determine if a predicted response was generated with each instruction followed correctly, determine what function to execute, determine whether or not to transition to a new state within a state machine, and so forth. The instructions can be retrieved or accessed from vector database 450, data store 460, a combination of these sources, as well as other sources.

Content 616 may include data and/or information that can assist an ML model or LLM generate an output. For an ML model, the content can include a stream of data that is put in a processable format (for example, normalized) for the ML model to read. For an LLM, the content can include a user inquiry, retrieved instructions, a content sketch, data associated with the present interaction, external world system, and current operations and data, policy data, checklist and/or checklist item data, programs and functions executed by a state machine, results of an audit or evaluation, and other content. In some instances, where only a portion of the content or a prompt will fit into an LLM input, the content and/or other portions of the prompt can be provided to an LLM can be submitted in multiple prompts.

Machine learning model 620 of FIG. 6 provides more detail for machine learning model 410 of FIG. 4. The ML model 620 may receive one or more inputs and provide an output. In some instances, the ML model may predict an output in the form of whether a policy was followed, whether a particular instruction is relevant, or some other prediction.

ML model 620 may be implemented by a large language model 622. A large language model is a machine learning model that uses deep learning algorithms to process and understand language. LLMs can have an encoder, a decoder, or both, and can encode positioning data to their input. In some instances, LLMs can be based on transformers, which have a neural network architecture, and have multiple layers of neural networks. An LLM can have an attention mechanism that allows them to focus selectively on parts of text. LLMs are trained with large amounts of data and can be used for different purposes.

The transformer model learns context and meaning by tracking relationships in sequential data. LLMs receive text as an input through a prompt and provide a response to one or more instructions. For example, an LLM can receive a prompt as an instruction to analyze data. The prompt can include a context (e.g., a role, such as ‘you are an agent’), a bulleted list of itemized instructions, and content to apply the instructions to.

In some instances, the present technology may use an LLM such as a BERT LLM, Falcon 30B on GitHub, Galactica by Meta, GPT-3 by OpenAI, or other LLM. In some instances, machine learning model 415 may be implemented by one or more other models or neural networks.

Output 630 is provided by machine learning model 620 in response to processing prompt 610 (e.g., an input). For example, when the prompt includes a request that the machine learning model identify the most relevant instructions from a set of content, the output will include a list of the most relevant instructions. In some instances, when the prompt includes a request that the machine learning model determine if an automated agent properly followed a set of instructions, a policy, or a checklist item during a conversation with a user, the machine learning model may return a confidence score, prediction, or other indication as to whether the instructions were followed correctly by the automated agent.

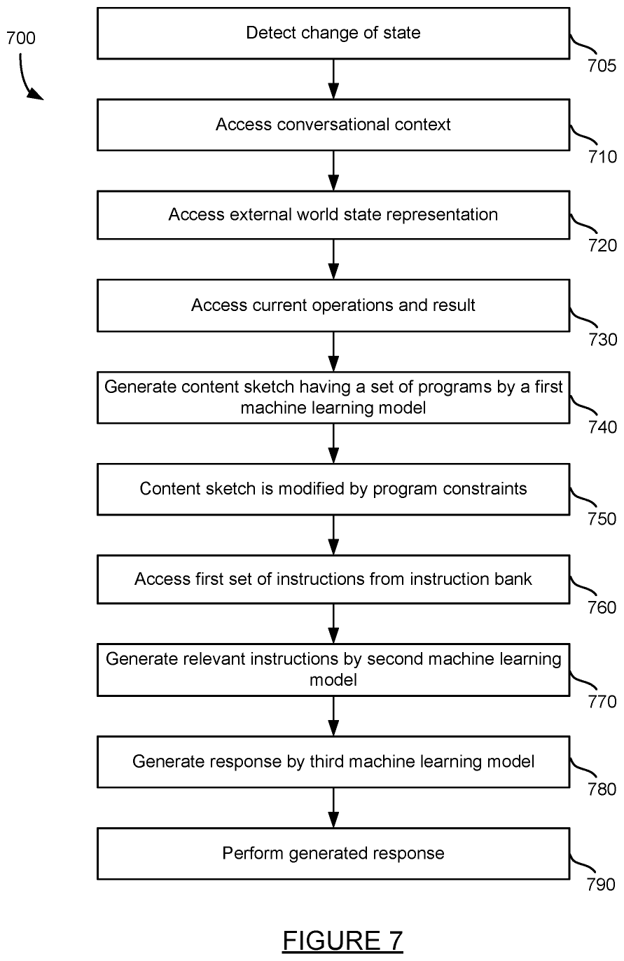

FIG. 7 illustrates a flow chart for generating a response to a change of state by an automated agent using structured based constraints. First, a change of state is detected at step 705. The change of state may be a new communication received in the interaction between the automated agent system and a client, an operation result received by the automated agent system, or some other event.

Once the change of state is detected, a response planning model is used to determine a content sketch. To generate the content sketch, the response planning model is provided with an input. The input can include conversational context, external world state representation, and current operations and results.

Conversational context is accessed at step 710. The conversational context can include a record of previous turns of interactions between the automated agent system and a client, such as for example in a customer service system environment. In some instances, the conversational context includes a record of previous turns of interactions between the automated agent system and the world, such as for example in the case of a navigation system. In some instances, the conversation context input provided as input to the response planning model is based on, a digest of, or trace of the record of previous turns of interactions between the system and the other entity in the current interaction.

External world state representation is accessed at step 720. The external state representation includes data and/or a representation of the state of systems with which the automated agent interacts. Examples of these systems include sensors, computing device keyboards or other inputs, or other devices that can provide data, signals, or information to the automated agent system.

Current operations and results are accessed at step 730. The current operations can include programs, procedures, partial reasoning traces, and other operations generated during the current turn by the system in an interaction with an entity (i.e., a client, the world, or other entity). The operation (program, procedure, trace, etc.) performed during the current turn can be in order to effectuate a goal by the automated agent system. Examples of operations and goals include a program to book a client's flight and the resulting confirmation number, a procedure to process a refund, an indication to move forward in an environment and the resulting updated coordinates from the world-model.

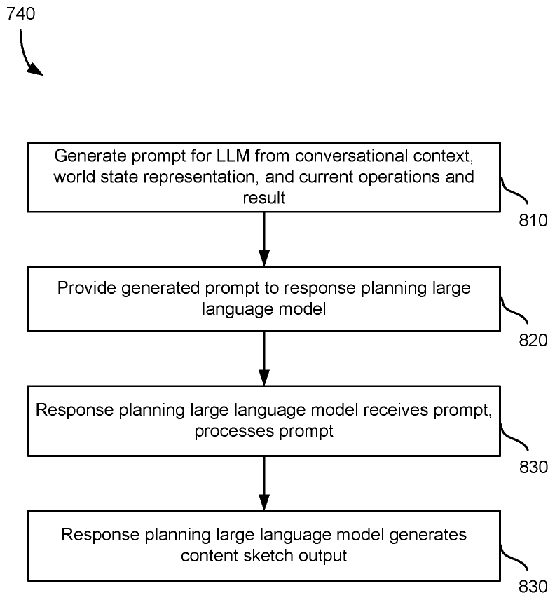

A content sketch can be generated at step 740. A content sketch is a plan for generating a response to the change in state. The content sketch can include a set of programs and is generated by a response planning model. In some instances, the response planning model is implemented as a machine learning model. In some instances, the content sketch is generated by providing inputs to the response planning model as shown in FIG. 2. More details for generating a content sketch are discussed with respect to the method of FIG. 8.

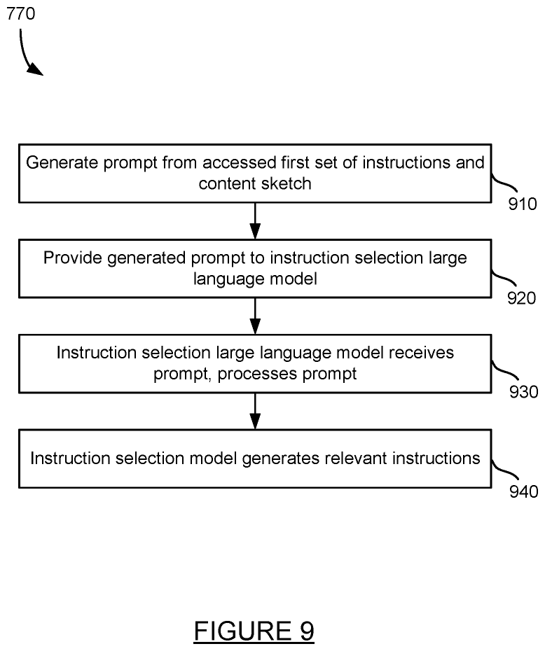

A content sketch output is modified by one or more program constraints at step 750. The content sketch may include one or more programs to execute based on the input received by the system. The one or more programs may be constrained to make them even more relevant to handling the change of state. Modifying a content sketch using program constraints is discussed in more detail with respect to the method of FIG. 10.

A first set of instructions is accessed from an instruction bank at step 760. In some instances, information from the change of state, such as content from an interaction between an automated agent system and client entity, is used to retrieve a first set of instructions from an instruction bank 245. The instruction bank 245 may be located at vector database 450, data store 460, locally from language model server 420, or some other location. The instructions contained in the instructions can be expressed in natural language or formal rules (e.g., parser/recognizer). The instructions can validate the content sketch, and can provide some additional information for how to generate a response to the change in state. The instructions can include general instructions that pertain to the automated agent in all scenarios as well as specific instructions that should only be followed in specific circumstances (e.g., “do not state [X] until information [Y] is obtained.”)

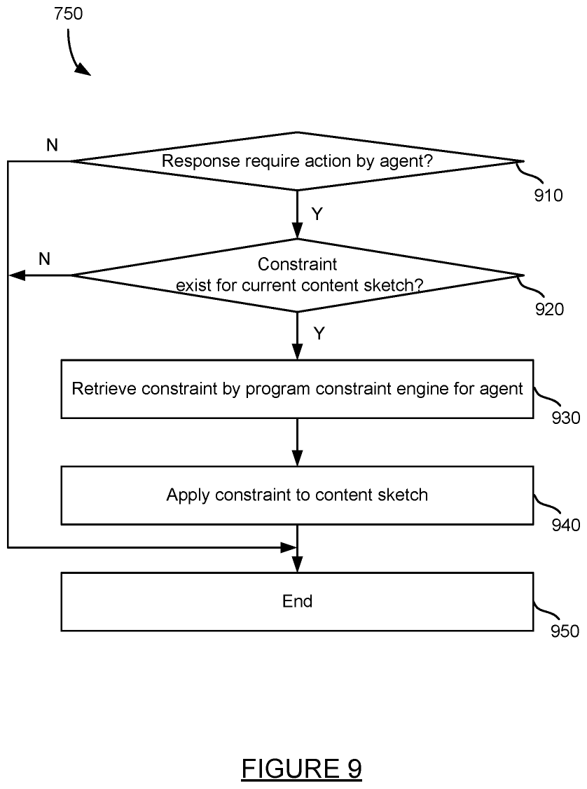

Relevant instructions may be generated by a machine learning model at step 770. The relevant instructions may be a subset of the instructions retrieved from the instruction bank and include instructions that are deemed most relevant to processing the change of state. In some instances, the first set of instructions and the content sketch may be provided to an instruction selection model to generate the relevant instructions. Generating relevant instructions is discussed in more detail with respect to the method of FIG. 9.

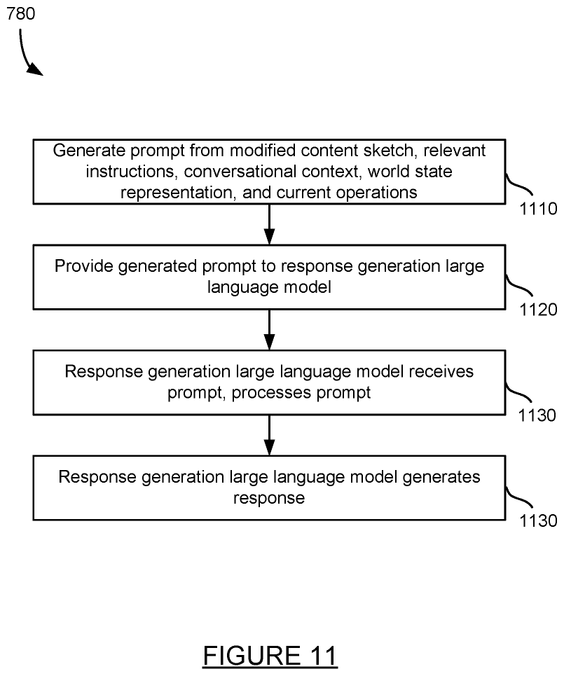

A response to the change of state is generated by a third machine learning model at step 780. The response is based on the relevant instructions, content sketch, and the input received by the automated agent system. Generating a response by third machine learning model is discussed in more detail below with respect to the method of FIG. 11.

The generated response is executed at step 790. The response may be performed in response to the change of state detected at step 705. The response may include generating a message for a client based on a client's recent message, performing an action, executing a program, processing a result, or some other response.

FIG. 8 illustrates a flow chart for generating a content sketch. The method of FIG. 8 provides more detail for step 740 in the method of FIG. 7. In some instances, the content sketch is generated when a response planning model is implemented as a large language model (LLM). When implemented by an LLM, a prompt is generated for the LLM from conversational context, world state representation, and current operations and results at step 810. The prompt may include the role of the automated agent or system, instructions to the large language model, and content. The generated prompt is provided to the response planning model at step 820. The response planning model receives the prompt and processes the prompt at step 830. The response planning model then generates a content sketch output at step 830.

A content sketch can include one or more programs and have several forms. A first example of a content sketch is below:

(r / respond-failure
:booking (b / booking-592653589)
:user (u / user-2643383279)
:reason (r1/ reason-date-constraint-violated)

The content sketch above is simple, where there is no ability or need to generate free text. The response is generated from a predefined set of “atoms.” The “reason” is given as one element from a set of possible reasons. The possible reasons are represented as an “enum” (short for “enumerated type”).

A second example of a content sketch is below:

(r / respond-failure
:booking (b / booking-592653589)
:user (u / user-2643383279)
:reason “Booking outside date window”

The second content sketch example, above, allows for generation of free text to provide an explanation for the response. A third example of a content sketch is below:

```
(p / possible
:ARG1 (b / book
  :ARG0 (i / I)
  :ARG1 (r / reservation)
  :booking-id 592653589
  :user user-2643383279
  :time (n / now))
:cause (o / outside
  :ARG0 r
  :ARG1 (w / window
    :ARG1-of (p2 / permit
      :polarity −)
    :modifier (d / date)))
:polarity −)
```

The third content sketch example, above, is an alternative expression of the second content sketch example. The third content sketch example avoids free text by using a larger set of atoms than the second content sketch example. Hence, a content sketch can include a constraint that the response does not include freely generated text.

FIG. 9 illustrates a flow chart for modifying a content sketch based on program constraints. The method of FIG. 9 provides more detail for step 750 in the method of FIG. 7. First, a determination is made as to whether the response requires an action by an agent at step 910.

The constraint can limit a value, variable, a particular program to access or execute, or provide some other constraint. For example, a content sketch used to generate a response may include a program to provide a client with a refund. The program constraint, in this example, may provide that the refund is limited to no more than $100.00. By applying the constraint, the present system can select instructions and/or generate a response more efficiently be reducing the work required to generate a more focused response.

If the response does not require an action by an automated agent, the method of FIG. 9 ends at step 950. If a response is required, a determination is made as to whether a constraint exists for the current content sketch at step 920. If no constraint exists, the method of FIG. 9 ends at step 950. If a constraint does exist for the content sketch, a program constraint engine retrieves a constraint for the current content sketch at step 930. The constraint may then be applied to the content sketch at step 940.

FIG. 10 illustrates a flow chart for generating relevant instructions by a machine learning model. The method of FIG. 10 provides more detail for step 770 in the method of FIG. 7. A prompt is generated from the accessed first set of instructions and the content sketch at step 1010. The prompt can include a role for the automated agent system, instructions to the model to identify the most relevant instructions, and content that includes a set of instructions from an instruction bank and a content sketch. The generated prompt is then provided to an instruction selection model at step 1020. The instruction selection model receives and processes the prompt at step 1030. The instruction selection model then generates relevant instructions at step 1040. The instructions will be selected as a subset of the instruction bank set of instructions based on the one or programs or other content within the content sketch.

FIG. 11 illustrates a flow chart of generating a response by a machine learning model. The method of FIG. 11 provides more detail for step 780 of the method of FIG. 7. First, a prompt is generated from a modified content sketch, relevant instructions, conversational context, world state representation, and current operations and results at step 1110. The prompt includes a role for the automated agent, instructions for the machine learning model, in some instances implemented as a large language model, to generate a response to the change in state, and content including the modified content sketch, relevant instructions, and input (conversational context, world state representation, and current operation and result). The generated prompt is then provided to a response generation model at step 1120. The response generation model receives the prompt and processes the prompt at step 1130. The response generation model then generates a proposed response as an output based on the prompt at step 1130.

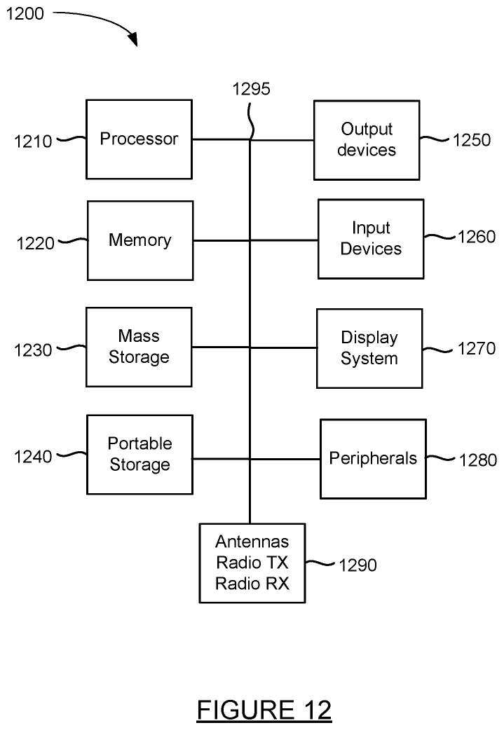

FIG. 12 is a block diagram of a computing environment for implementing the present technology. System 1200 of FIG. 12 may be implemented in the contexts of the likes of machines that implement machine learning model 110, application server 120, chat application server 130, and simulation server 140. The computing system 1200 of FIG. 12 includes one or more processors 1210 and memory 1220. Main memory 1220 stores, in part, instructions and data for execution by processor 1210. Main memory 1220 can store the executable code when in operation. The system 1200 of FIG. 12 further includes a mass storage device 1230, portable storage medium drive(s) 1240, output devices 1250, user input devices 1260, a graphics display 1270, and peripheral devices 1280.

The components shown in FIG. 12 are depicted as being connected via a single bus 1295. However, the components may be connected through one or more data transport means. For example, processor unit 1210 and main memory 1220 may be connected via a local microprocessor bus, and the mass storage device 1230, peripheral device(s) 1280, portable storage device 1240, and display system 1270 may be connected via one or more input/output (I/O) buses.

Mass storage device 1230, which may be implemented with a magnetic disk drive, an optical disk drive, a flash drive, or other device, is a non-volatile storage device for storing data and instructions for use by processor unit 1210. Mass storage device 1230 can store the system software for implementing embodiments of the present invention for purposes of loading that software into main memory 1220.

Portable storage device 1240 operates in conjunction with a portable non-volatile storage medium, such as a floppy disk, compact disk or Digital video disc, USB drive, memory card or stick, or other portable or removable memory, to input and output data and code to and from the computer system 1200 of FIG. 12. The system software for implementing embodiments of the present invention may be stored on such a portable medium and input to the computer system 1200 via the portable storage device 1240.

Input devices 1260 provide a portion of a user interface. Input devices 1260 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, system 1200 as shown in FIG. 12 includes output devices 1250. Examples of suitable output devices include speakers, printers, network interfaces, and monitors.

Display system 1270 may include a liquid crystal display (LCD) or other suitable display device. Display system 1270 receives textual and graphical information and processes the information for output to the display device. Display system 1270 may also receive input as a touch-screen.

Peripherals 1280 may include any type of computer support device to add additional functionality to the computer system. For example, peripheral device(s) 1280 may include a modem or a router, printer, and other device.

The system of 1200 may also include, in some implementations, antennas, radio transmitters and radio receivers 1290. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1200 of FIG. 12 are those typically found in computer systems that may be suitable for use with embodiments of the present invention and are intended to represent a broad category of such computer components that are well known in the art. Thus, computer system 1200 of FIG. 12 can be a personal computer, handheld computing device, smart phone, mobile computing device, tablet computer, workstation, server, minicomputer, mainframe computer, or any other computing device. The computer can also include different bus configurations, networked platforms, multi-processor platforms, etc. The computing device can be used to implement applications, virtual machines, computing nodes, and other computing units in different network computing platforms, including but not limited to AZURE by Microsoft Corporation, Google Cloud Platform (GCP) by Google Inc., AWS by Amazon Inc., IBM Cloud by IBM Inc., and other platforms, in different containers, virtual machines, and other software. Various operating systems can be used including UNIX, LINUX, WINDOWS, MACINTOSH OS, CHROME OS, IOS, ANDROID, as well as languages including Python, PHP, Java, Ruby,.NET, C, C++, Node.JS, SQL, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for generating a response to a change of state using structured based constraints, comprising:
detecting a change of state by an automated agent during a conversation;
accessing conversational context, external world state representation, and current agent operations data associated with the conversation;
generating a content sketch based on the accessed conversational context, external world state representation, and current agent operations data, the content sketch generated using a first machine learning model, the content sketch including a set of one or more programs; and
preparing a response based at least in part on the content sketch and a first set of instructions, the first set of instructions identified based on the content sketch and the change of state.

2. The method of claim 1, further including applying a program constraint to the content sketch before the response is prepared, the program constraint associated with at least one program in a set of one or more programs included in the content sketch.

3. The method of claim 1, further comprising:
accessing instructions from an instruction bank; and
selecting a set of relevant instructions as a sub-set of the instructions accessed from the instruction bank, the set of relevant instructions selected at least in part on the content sketch, the set of relevant instructions being relevant to preparing a response to the communication.

4. The method of claim 1, wherein identified instructions are selected as a subset of relevant instructions from a second larger set of instructions.

5. The method of claim 1, wherein the content sketch provides a constraint that the response does not include freely generated text.

6. The method of claim 1, wherein the content sketch allows for generation of free text to provide an explanation for the response.

7. The method of claim 1, wherein the response is generated by a large language machine, wherein the prompt for the large language machine is based at least in part on the content sketch, the relevant instructions, and conversational context, external world state representation, and current agent operations data.

8. The method of claim 1, wherein the change of state includes receipt of a message from a client.

9. The method of claim 1, wherein the change of state includes a development while executing a program related to a client request.

10. A non-transitory computer readable storage medium having embodied thereon a program, the program being executable by a processor to generating a response to a change of state using structured based constraints, the method comprising:
detecting a change of state by an automated agent during a conversation;
accessing conversational context, external world state representation, and current agent operations data associated with the conversation;
generating a content sketch based on the accessed conversational context, external world state representation, and current agent operations data, the content sketch generated using a first machine learning model, the content sketch including a set of one or more programs; and
preparing a response based at least in part on the content sketch and a first set of instructions, the first set of instructions identified based on the content sketch and the change of state.

11. The non-transitory computer readable storage medium of claim 10, further including applying a program constraint to the content sketch before the response is prepared, the program constraint associated with at least one program in a set of one or more programs included in the content sketch.

12. The non-transitory computer readable storage medium of claim 10, the method further comprising:
accessing instructions from an instruction bank; and
selecting a set of relevant instructions as a sub-set of the instructions accessed from the instruction bank, the set of relevant instructions selected at least in part on the content sketch, the set of relevant instructions being relevant to preparing a response to the communication.

13. The non-transitory computer readable storage medium of claim 10, wherein identified instructions are selected as a subset of relevant instructions from a second larger set of instructions.

14. The non-transitory computer readable storage medium of claim 10, wherein the content sketch provides a constraint that the response does not include freely generated text.

15. The non-transitory computer readable storage medium of claim 10, wherein the content sketch allows for generation of free text to provide an explanation for the response.

16. The non-transitory computer readable storage medium of claim 10, wherein the response is generated by a large language machine, wherein the prompt for the large language machine is based at least in part on the content sketch, the relevant instructions, and conversational context, external world state representation, and current agent operations data.

17. The non-transitory computer readable storage medium of claim 10, wherein the change of state includes receipt of a message from a client.

18. The non-transitory computer readable storage medium of claim 10, wherein the change of state includes a development while executing a program related to a client request.

19. A system for generating a response to a change of state using structured based constraints, comprising:
one or more servers, wherein each server includes a memory and a processor; and
one or more modules stored in the memory and executed by at least one of the one or more processors to detect a change of state by an automated agent during a conversation, access conversational context, external world state representation, and current agent operations data associated with the conversation, generate a content sketch based on the accessed conversational context, external world state representation, and current agent operations data, the content sketch generated using a first machine learning model, the content sketch including a set of one or more programs, and prepare a response based at least in part on the content sketch and a first set of instructions, the first set of instructions identified based on the content sketch and the change of state.

20. The system of claim 1, the one or more modules further executable to apply a program constraint to the content sketch before the response is prepared, the program constraint associated with at least one program in a set of one or more programs included in the content sketch.
